(19) United States
(12) Patent Application Publication
(10) Pub. No.: US 2013/0046644 A1
(43) Pub. Date: Feb. 21, 2013

(54) COMMODITY ACCOMMODATION APPARATUS, COMMODITY REGISTRATION APPARATUS AND COMMODITY REGISTRATION METHOD

(71) Applicant: Naoto Sano, Shizuoka-ken (JP)

(72) Inventor: Naoto Sano, Shizuoka-ken (JP)

(73) Assignee: TOSHIBA TEC KABUSHIKI KAISHA, Tokyo (JP)

(21) Appl. No.: 13/584,103

(22) Filed: Aug. 13, 2012

(30) Foreign Application Priority Data
Aug. 17, 2011 (JP) 2011-178541

(51) Int. Cl. G06Q 20/20; G06Q 20/40

(52) U.S. Cl. 705/18; 705/23

(57) ABSTRACT

A commodity accommodation apparatus comprises an accommodation unit configured to accommodate commodities, a shooting unit configured to shoot an image of the interior of the accommodation unit and a sending section configured to send an identification information for specifying one's own identity and the shot image to a commodity registration apparatus.

### CROSS-REFERENCE TO RELATED APPLICATION

This application is based upon and claims the benefit of priority from Japanese Patent Application No. 2011-178541, filed Aug. 17, 2011, the entire contents of which are incorporated herein by reference.

### FIELD

Embodiments described herein relate to a commodity accommodation apparatus, a commodity registration apparatus and a commodity registration method.

### BACKGROUND

A customer shopping in a supermarket or the like places the selected commodities in a shopping basket and delivers the shopping basket containing all the selected commodities to a shop assistant. The shop assistant registers the sales of the commodities in the shopping basket while recognizing the commodities.

### BRIEF DESCRIPTION OF THE DRAWINGS

FIG. 1 is a perspective view of a checkout lane system;

FIG. 2 is a diagram roughly illustrating the components of a shopping cart;

FIG. 3 is a block diagram showing the hardware components of a POS terminal and a shopping cart having a shopping basket on the holding table thereof;

FIG. 4 is a conceptual diagram exemplarily showing the data structure of a PLU file;

FIG. 5 is a block diagram showing the functional units of the CPUs of a POS terminal and a shopping basket loaded on a shopping cart;

FIG. 6 is a flow chart showing an example of the actions carried out by a shopping basket according to an embodiment;

FIG. 7 is a flow chart showing an example of the actions carried out by a POS terminal according to an embodiment;

FIG. 8 is a diagram illustrating the commodity sales registration actions carried out when commodities are added to a shopping basket;

FIG. 9 is a diagram illustrating the commodity sales registration actions carried out when commodities are taken out of a shopping basket;

FIG. 10 is a diagram illustrating the commodity list generation actions carried out when the commodities in a shopping basket are recognized through object recognition;

FIG. 11 is a flow chart showing an example of the checkout actions carried out by a POS terminal according to an embodiment.

### DETAILED DESCRIPTION

In accordance with an embodiment, a commodity accommodation apparatus comprises an accommodation unit configured to accommodate commodities, a shooting unit configured to shoot an image of the interior of the accommodation unit and a sending section configured to send an identification information for specifying one's own identity and the shot image to a commodity registration apparatus.

By taking a checkout lane system as an example, the commodity accommodation apparatus, the commodity registration apparatus and the commodity registration method provided in this embodiment are described below with reference to accompanying drawings. In accordance with this embodiment, a checkout lane system refers to a checkout lane system (e.g. POS system) having a POS (Point Of Sales) terminal for the registration and checkout of the commodities settled in a transaction. This embodiment is an application example of a checkout lane system installed in a supermarket or the like.

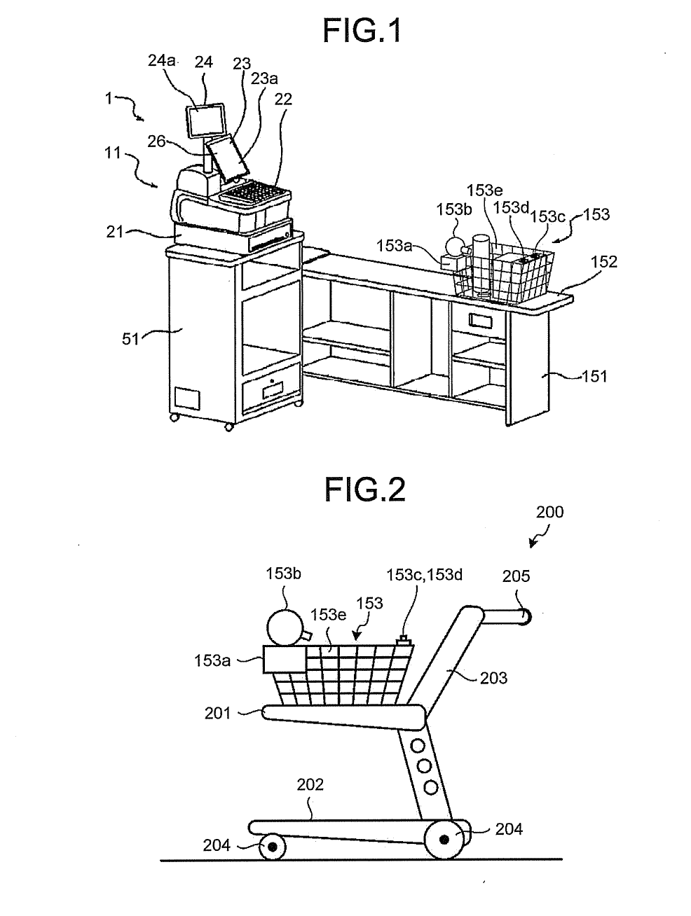

FIG. 1 is a perspective view of the checkout lane system. FIG. 2 is a diagram roughly illustrating the components of a shopping cart. As shown in FIG. 1, the checkout lane system 1 has a POS terminal 11 for the registration and checkout of the commodities settled in a transaction. The POS terminal 11 is arranged on the upper surface of a cash drawer 21 on a checkout counter 51. The cash drawer 21 is opened under the control of the POS terminal 11. A keyboard 22 for the operator (user) to press down is arranged on the upper surface of the POS terminal 11. Seen from the operator of the keyboard 22, a display 23 for displaying information for the operator is arranged more interior than the keyboard 22. The display 23 displays information on the display panel 23a thereof. A touch panel 26 is laminated on the display panel 23a. A vertical customer-oriented display 24 is rotationally and freely arranged at a position more interior than the display 23. The costumer-oriented display 24 displays information on the display panel 24a thereof. Moreover, in FIG. 1, the display panel 24a of the customer-oriented display 24 faces the near front side of FIG. 1, however, by rotating the customer-oriented display 24, the display panel 24a may also face the inner side of FIG. 1 so that the customer-oriented display 24 can show information for the customer.

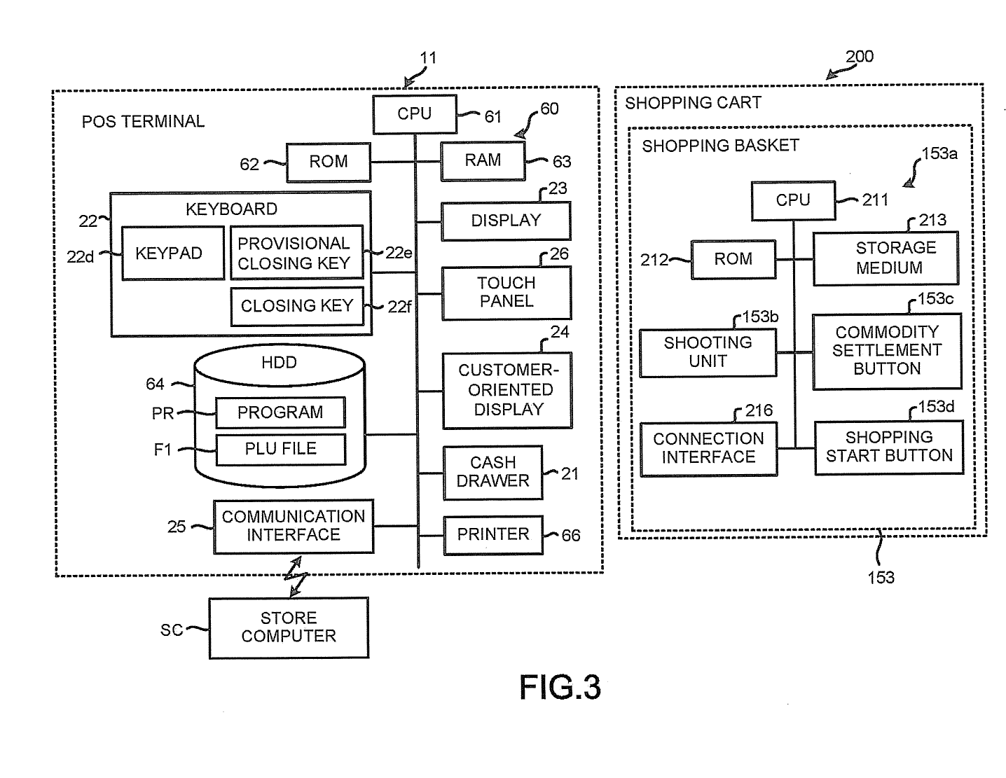

A long horizontal desk-shaped counter 151 is provided which forms an L shape with a checkout counter 51 equipped with the POS terminal 11. A commodity receiving surface 152 is formed on the upper surface of the counter 151 to hold a shopping basket taken away from a shopping cart 200. The shopping basket 153 is a commodity accommodation device for accommodating the commodities purchased by a customer. In this embodiment, the shopping basket 153 comprises: an accommodation unit 153e for accommodating commodities; a shooting unit 153b for shooting an image of the commodities in the accommodation unit 153e; a control unit 153a equipped with a storage medium 213 (refer to FIG. 3) in which a commodity list of the sales-registered ones of the commodities accommodated in the shopping basket 153 and a shopping basket ID for specifying the identification information of the shopping basket 153 are stored; a commodity settlement button 153c for sending the commodity list and the shopping basket ID stored in the storage medium 213 (refer to FIG. 3) to the POS terminal 11 to instruct a settlement on the commodities contained in the commodity list; and a shopping start button 153d for instructing the start of a shopping. As shown in FIG. 2, the customer shopping in a shop places the shopping basket 153 on the holding table 201 or 202 of the shopping cart 200 and then shops with the shopping cart 200. The shopping cart 200 comprises: a frame 203, holding tables 201 and 202 for holding shopping baskets 153, four bottom wheels 204, and a handle 205 arranged at the rear part of the frame 203. The customer can hold the handle 205 to move the shopping cart 200 in a desired direction.

Moreover, the shopping cart 200 itself may be a commodity accommodation device equipped with an accommodation unit for accommodating commodities. For instance, the shopping cart 200 may be in the following form: a net is spread on the frame 203 of the shopping cart 200 so that commodities can be visibly accommodated, and in this case, the shopping cart 200 itself serves as an accommodation unit.

The commodity sales registration processing carried out by the checkout lane system 1 is described briefly here. After the shopping start button 153e of the shopping basket 153 is pressed down, the POS terminal 11 receives the image shot by the shooting unit 153b and a shopping basket ID from the shopping basket 153. Then, the POS terminal 11 recognizes the commodities accommodated in the shopping basket 153 according to the received shot image. Next, for each shopping basket specified by the received shopping basket ID, the POS terminal 11 generates a commodity list to record the recognized commodities. Further, the POS terminal 11 stores the generated commodity list in the storage medium 213 arranged in the shopping basket 153 specified by the shopping basket ID, thereby registering the sales of the recognized commodities for each shopping basket specified by the received shopping basket ID. Sequentially, after the commodity settlement button 153c of the shopping basket 153 is pressed down, and the POS terminal 11 receives the commodity list and the shopping basket ID from the shopping basket 153. Then, the POS terminal 11 settles the commodities contained in the received commodity list as the commodities accommodated in the shopping basket 153 specified by the received shopping basket ID.

FIG. 3 is a block diagram showing the hardware components of the POS terminal and a shopping cart having a shopping basket on the holding table thereof. The POS terminal 11 is provided with a micro computer 60 which functions as an information processing unit to carry out an information processing. The micro computer 60 is formed by connecting a CPU (Central Processing Unit) 61 for carrying out various operations to control each other unit with an ROM (Read Only Memory) 62 and an RAM (Random Access Memory) 63 via a bus line.

The CPU 61 of the POS terminal 11 is connected with the cash drawer 21, the keyboard 22, the display 23, the touch panel 26 and the customer-oriented display 24 via various input/output circuits (not shown). The components connected with the CPU 61 of the POS terminal 11 are controlled by the CPU 61.

The keyboard 22 includes a numeric keypad 22d consisting of numeric keys ‘1’, ‘2’, ‘3’ and so on and operator keys such as ‘*’ (Multiplication Symbol), a provisional closing key 22e and a closing key 22f.

The CPU 61 of the POS terminal 1 is connected with an HDD (Hard Disk Drive) 64, in which programs and files are stored. When run in the POS terminal 11, the programs and files stored in the HDD 64 are wholly or partially copied to the RAM 63 to be sequentially executed by the CPU 61. An example of a program stored in the HDD 64 is PR (Program for Sales Registration). An example of a file stored in the HDD64 is a PLU file F1 that is sent from a store computer SC and then stored.

The PLU file F1 is a commodity primary file in which the sales registration information of each commodity sold in a shop is associated with the image of the commodity.

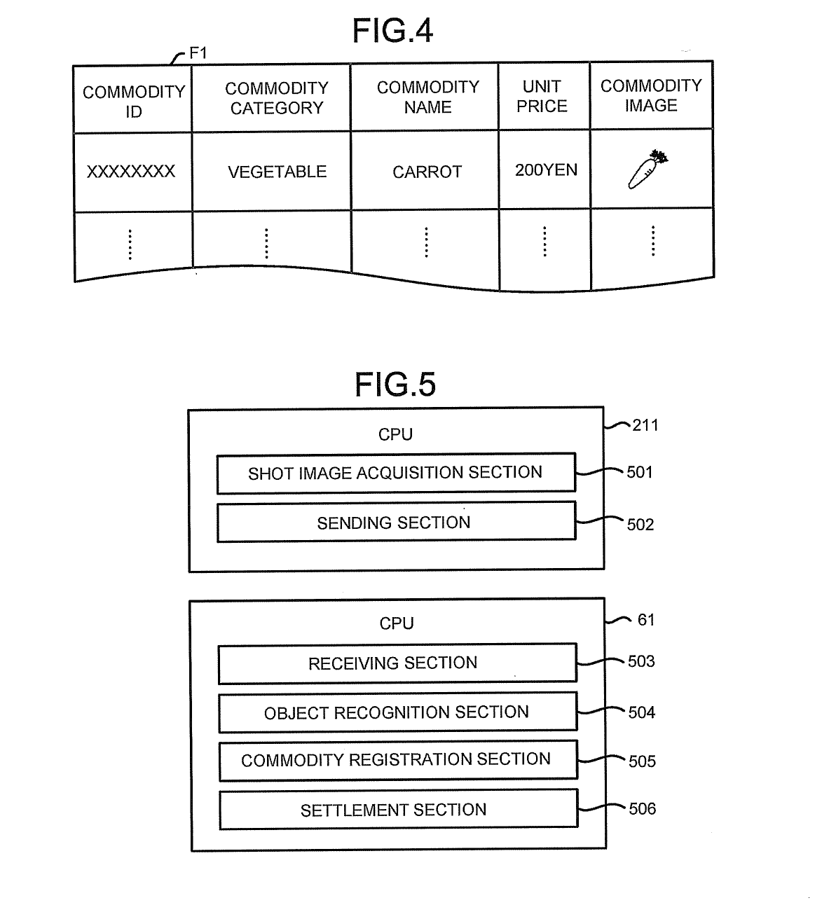

FIG. 4 is a conceptual diagram exemplarily showing the data structure of the PLU file. As shown in FIG. 4, the PLU file F1 is a file which stores a unique commodity ID, a category, a commodity name, a unit price and a shot commodity image for each commodity. Such a PLU file F1 is classified according to the category (e.g. bread, fruit, home style cooking) of object commodities.

Return to FIG. 3, the CPU 61 of the POS terminal 1 is connected, via an input-output circuit (not shown), with a communication interface 25 that communicates in data with the store computer SC as well as the shopping cart 200. The store computer SC is arranged in the backyard of a shop. The PLU file F1 to be sent to the POS terminal 11 is stored in the HDD (not shown) of the store computer Sc.

The CPU 61 of the POS terminal 11 is further connected with a printer 66 for printing invoices. Under the control of the CPU 61, the POS terminal 11 prints the content of a transaction on a receipt.

The shopping basket 153 loaded on the holding table 201 or 202 of the shopping cart 200 is also provided with a control unit 153a serving as a micro computer. The control unit 153a is formed by connecting a CPU 211 with an ROM 212 and a storage medium (RAM) 213 via a bus line. The programs executed by the CPU 211 are stored in the ROM 212. The CPU 211 is connected with the shooting unit 153b, the commodity settlement button 153c and the shopping start button 153d via various input/output circuits (not shown). The shooting unit 153b acts under the control of the CPU 211.

The shooting unit 153b is a color CCD (Charged Coupled device) image sensor or a color CMOS (Complementary Metal Oxide Semiconductor) image sensor which shoots an image of the commodities accommodated in the shopping basket 153 from above the shopping basket 153 under the control of the CPU 211. For instance, the shooting unit 153b shoots dynamic images at 30 fps. The frame images (shot images) sequentially shot by the shooting unit 153b at a given frame rate are stored in the storage medium 213. In addition to the frame images, a commodity list and a shopping basket ID are also stored in the storage medium 213, as stated above.

The CPU 211 of the shopping basket 153 is further connected, via an input-output circuit (not shown), with a communication interface 216 that communicates in data with the POS terminal 11.

Next, the functional units of the CPUs 61 and 211 achieved by the sequential running of the PR by the CPUs 61 and 211 are described with reference to FIG. 5. FIG. 5 is a block diagram showing the functional units of the CPUs of a POS terminal and a shopping basket loaded on a shopping cart. As shown in FIG. 5, by executing programs in succession, the CPU 211 functions as a shot image acquisition section 501 and a sending section 502. In the same way, the CPU 61 functions as a receiving section 503, an object recognition section 504, a commodity registration section 505 and a settlement section 506.

After the start of a shopping is instructed after the shopping start button 153d is pressed down, the shot image acquisition section 501 outputs a shooting-on signal to the shooting unit 153b to instruct the shooting unit 153b to start a shooting. After the shooting is started, the shot image acquisition section 501 sequentially acquires, at regular intervals, the frame images that are shot by the shooting unit 153b and stored in the storage medium 213. The shot image acquisition section 501 acquires the frame images in accordance with the storage order of the images in the storage medium 213. After a commodity settlement is instructed after the commodity settlement button 153c is pressed down, the shot image acquisition section 501 outputs a shooting-off signal to the shooting unit 153b to instruct the shooting unit 153b to end the shooting.

When the shot image acquisition section 501 acquires a frame image, the sending section 502 sends, via the communication interface 216, the shopping basket ID stored in the storage medium 213 and the acquired frame image to the POS terminal 11 to request for a sales registration for the commodities accommodated in the shopping basket 153. Moreover, in the case where the shot image acquisition section 501 acquires frame images for more than two times after the shopping start button 153d is pressed down, in addition to the frame images and the shopping basket ID, the sending section 502 also sends the commodity list stored in the storage medium 213 to the POS terminal 11 to request for a sales registration for the commodities accommodated in the shopping basket 153.

Further, when the commodity settlement button 153c is pressed down, the sending section 502 sends, via the communication interface 216, the shopping basket ID and the commodity list stored in the storage medium 213 to the POS terminal 11 to request for a commodity settlement for the commodities accommodated in the shopping basket 153.

After the shopping start button 153d of the shopping basket 153 is pressed down, the receiving section 503 receives a frame image and a shopping basket ID from the shopping basket 153 via the communication interface 25 every time the shot image acquisition section 501 acquires a frame image (that is, every a given period of time). Moreover, in the case where the shot image acquisition section 501 acquires frame images for more than two times after the shopping start button 153d is pressed down, the receiving section 503 receives the frame images and the shopping basket ID from the shopping basket 153 as well as the commodity list stored in the storage medium 213.

Further, after the commodity settlement button 153c of the shopping basket 153 is pressed down, the receiving section 503 receives the shopping basket ID and the commodity list from the shopping basket 153 via the communication interface 25.

By reference to a commodity image in the PLU file F1, the object recognition section 504 recognizes, according to a frame image received by the receiving section 503, the commodity specified by the frame image and accommodated in the shopping basket 153 specified by the shopping basket ID. Specifically, by reference to the PLU file F1, the object recognition section 504 reads, according to a frame image, surface states (e.g. color tone, surface flatness level) as characteristics to recognize a commodity serving as a specific object. Moreover, the object recognition section 504 takes no consideration of the outline or size of a commodity so as to shorten the processing time. According to the recognition result of the object recognition section 50, the POS terminal 11 specifies the commodities accommodated in the shopping basket 153 from the commodities that are pre-registered in the PLU file F1 4.

The recognition of an object contained in an image is referred to as generic object recognition, which is realized by various recognition technologies that are respectively illustrated in the following documents:

YANAI Keiji, ‘The current state and further directions on Generic Object Recognition’, in Proceedings of Information Processing Society of Japan, Vol. 48, No SIG 16, In URL:http://mm.cs.uec.ac.jp/IPSJ-TCVIM-Yanai.pdf [retrieved on Aug. 10, 2010].

In addition, the technology for recognizing a generic object through a target-aimed regional image segmentation is described in the following document:

Jamie Shotton: “Semantic Texton Forests for Image Categorization and Segmentation”, In URL:http://citeseerx.ist.psu.edu/viewdoc/download?doi=10. 1.1.145.3036&rep=repl&type=pdf (retrieved on Aug. 10, 2010).

In the case where the receiving section 503 receives a frame image and a shopping basket ID to request for a sales registration for commodities, the commodity registration section 505 registers the sales of the commodities recognized by the object recognition section 504 for each shopping basket 153 specified by the frame image from which commodities are recognized as well as the received shopping basket ID. Specifically, the commodity registration section 505 reads the sales registration information of the recognized commodities from the PLU file F1. Then, the commodity registration section 505 generates a commodity list in which the read sales registration information is recorded. Next, the commodity registration section 505 stores the generated commodity list in the storage medium 213 arranged in the shopping basket 153 specified by the received shopping basket ID, thereby registering the sales of the recognized commodities for each shopping basket 153.

Further, in the case where the receiving section 503 receives a frame image, a shopping basket ID and a commodity list to request for a sales registration for commodities, the commodity registration section 505 compares the commodities recognized by the object recognition section 504 with the ones the sales of which is registered for the shopping basket 153 specified by the received shopping basket ID (the commodities the sales registration information which is recorded in the received commodity list) to determine whether or not commodities are added to or taken out of the shopping basket 153.

Then, in the case where it is determined that commodities are added to the shopping basket 153, the commodity registration section 505 reads, from the PLU file F1, the sales registration information of the ones of the recognized commodities the sales registration information of which is not recorded in the received commodity list. Then, the commodity registration section 505 records the read sales registration information in the received commodity list, and stores the commodity list containing the read sales registration information in the storage medium 213 of the shopping basket 153 specified by the received shopping basket ID. In this way, the commodity registration section 505 registers the sales of the ones of the recognized commodities that are not registered in sales for the shopping basket 153 specified by the received shopping basket ID.

On the other hand, if it is determined there are commodities taken out of the shopping basket 153, the commodity registration section 505 specifies the commodities which are not included in the recognized commodities and the sales registration information of which is not recorded in the received commodity list. Then, the commodity registration section 505 deletes the sales registration information of the specified commodities from the received commodity list. Next, the commodity registration section 505 stores the commodity list containing no sales registration information of the specified commodities in the storage medium 213 of the shopping basket 153 specified by the received shopping basket ID. In this way, the commodity registration section 505 removes the registration on the sales of the commodities which are not included in the recognized commodities but the sales of which is registered for the shopping basket 153 specified by the received shopping basket ID.

When the commodity settlement button 153c of the shopping basket 153 is pressed down to request for a commodity settlement, the settlement section 506 settles the commodities the sales information of which is recorded in the commodity list received by the receiving section 503.

Moreover, after the commodities the sales registration information of which is recorded in the commodity list are settled, the settlement section 506 deletes the commodity list stored in the storage medium 213 of the shopping basket 153 specified by the received shopping basket ID.

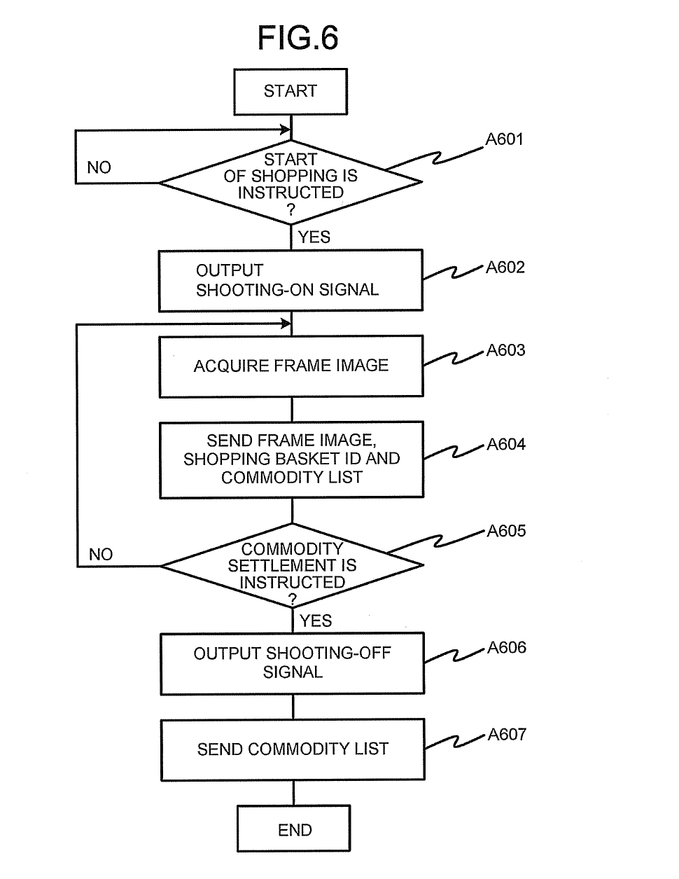

Next, the actions carried out by the shopping basket 153 in this embodiment are described in detail. FIG. 6 is a flow chart showing an example of the actions carried out by the shopping basket according to this embodiment;

When the start of a shopping is instructed after the shopping start button 153d (A601: Yes) is pressed down, the shot image acquisition section 501 outputs a shooting-on signal to the shooting unit 153b to instruct the shooting unit 153b to start a shooting (A602).

After the shooting unit 153b starts a shooting, the shot image acquisition section 501 suequentially acquires, at regular intervals, the frame images that are shot by the shooting unit 153b and stored in the storage medium 213 (A603). After the shot image acquisition section 501 acquires a frame image, the sending section 502 sends, via the communication interface 216, the acquired frame image and the shopping basket ID stored in the storage medium 213 to the POS terminal 11 to request for a sales registration for the commodities accommodated in the shopping basket 153 (A 604). Moreover, in the case where the shot image acquisition section 501 acquires frame images for more than two times after the shopping start button 153d is pressed down, in addition to the frame images and the shopping basket ID, the sending section 502 also sends the commodity list stored in the storage medium 213 to the POS terminal 11 via the communication interface 216 so as to request for a sales registration for the commodities accommodated in the shopping basket 153.

Next, the shot image acquisition section 501 determines whether or not the commodity settlement button 153c is pressed down to instruct a commodity settlement (A605). If the commodity settlement button 153c is not pressed down (A605: No), the shot image acquisition section 501 continues to acquire a frame image.

On the other hand, if the commodity settlement button 153c is pressed down to instruct a commodity settlement (A605: Yes), the shot image acquisition section 501 outputs a shooting-off signal to the shooting unit 153b to stop the shooting (A606). Further, if a commodity settlement is instructed (A605: Yes), the sending section 502 outputs the shopping basket ID and the commodity list stored in the storage medium 213 to the POS terminal 11 via the communication interface 216 to request for a commodity settlement (A607).

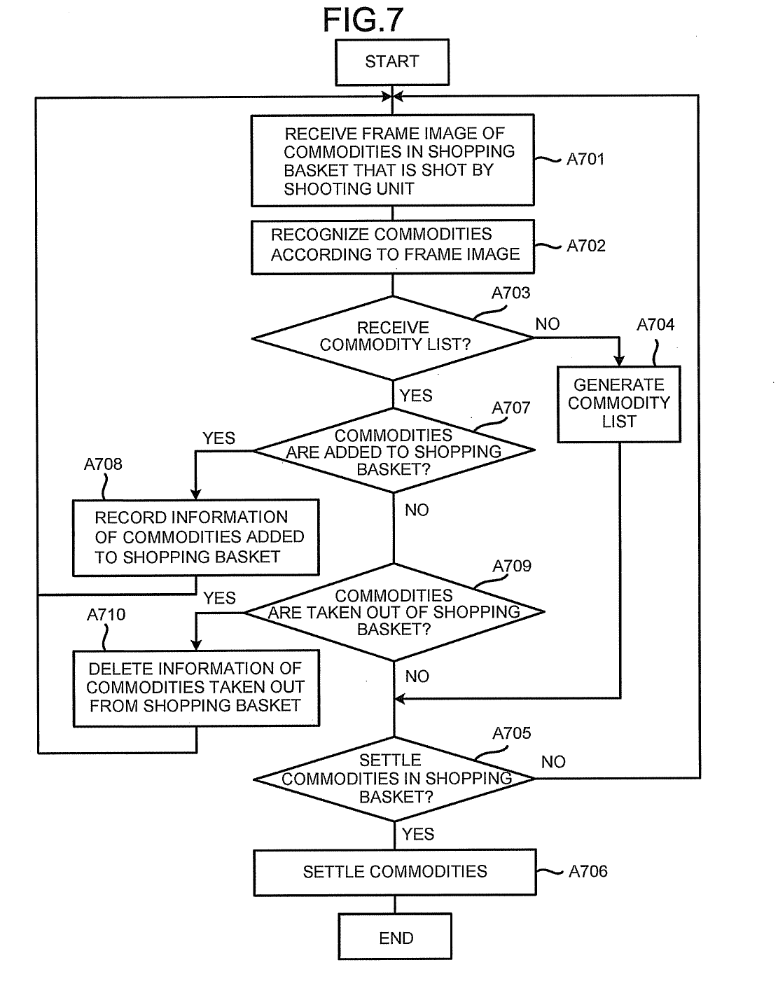

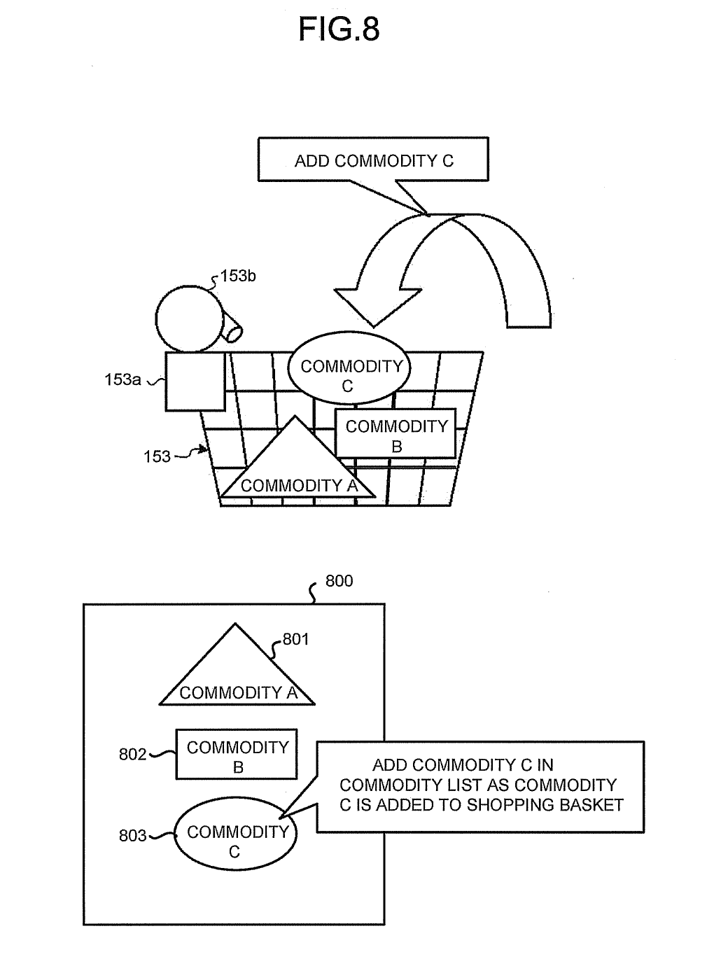

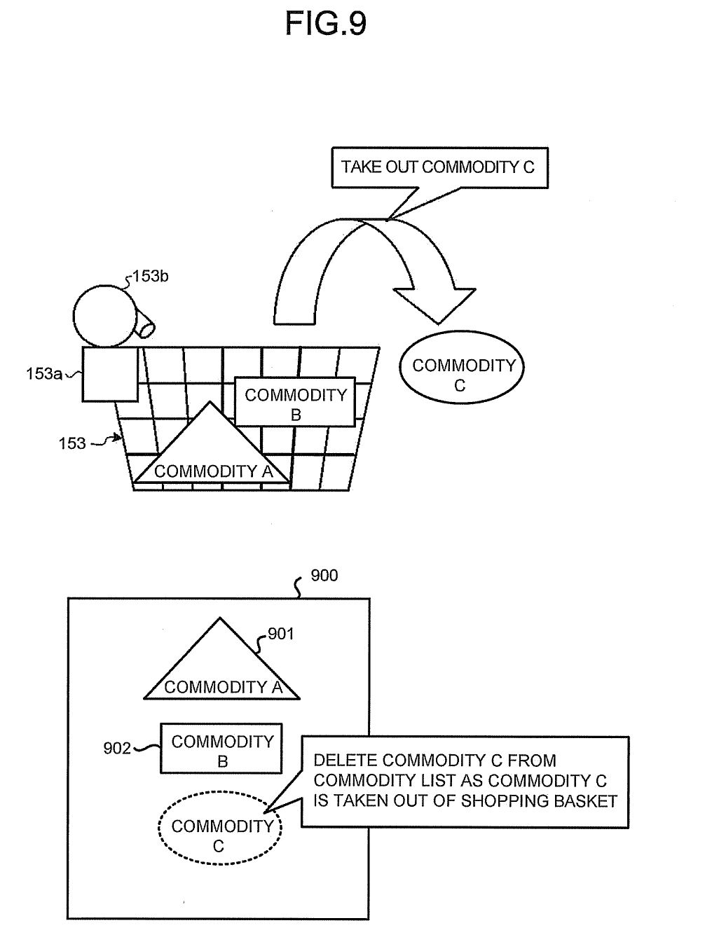

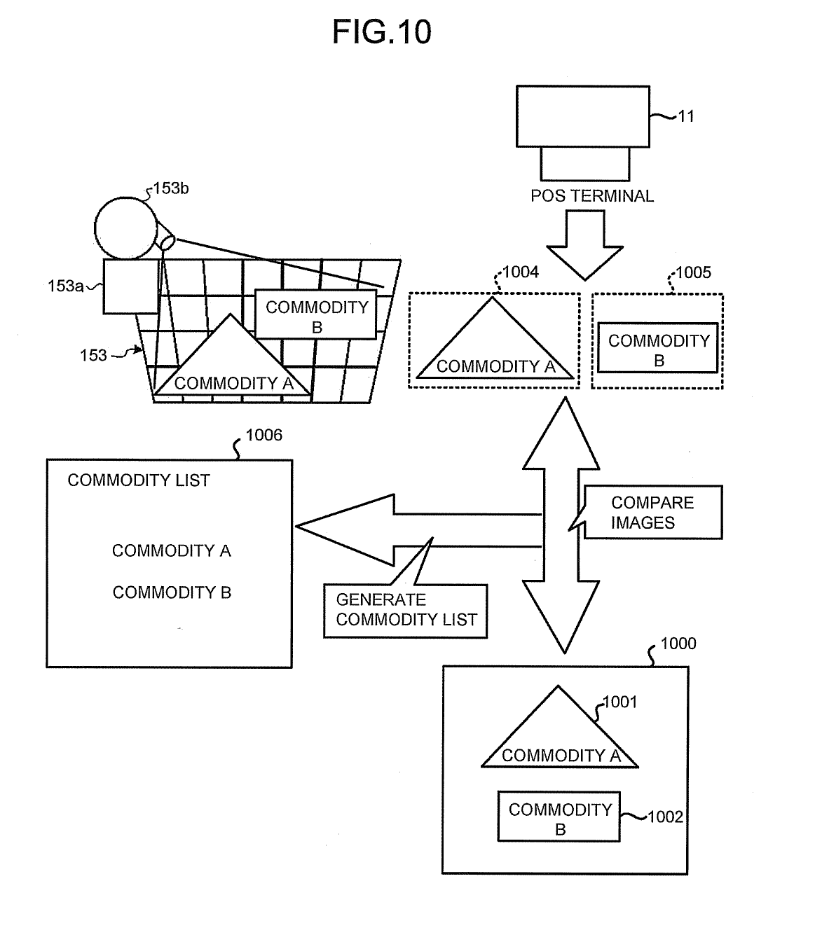

Next, the actions carried out by the POS terminal 11 in this embodiment are described. FIG. 7 is a flow chart showing an example of the actions carried out by the POS terminal according to this embodiment. FIG. 8 is a diagram illustrating the commodity sales registration actions carried out when commodities are added to a shopping basket. FIG. 9 is a diagram illustrating the commodity sales registration actions carried out when commodities are taken out of a shopping basket. FIG. 10 is a diagram illustrating the commodity list generation actions carried out when the commodities in a shopping basket are recognized through object recognition.

The receiving section 503 receives, via the communication interface 25, a frame image sent by the sending section 502, that is, a frame image of the commodities in the shopping basket 153 shot by the shooting unit 153c arranged on the shopping basket 153, and the shopping basket ID stored in the storage medium 213 (A701). Moreover, in the case where the shot image acquisition section 501 acquires frame images for more than two times after the shopping start button 153d is pressed down, in addition to the frame images and the shopping basket ID, the receiving section 503 also receives the commodity list stored in the storage medium 213 of the shopping basket 153.

After receiving the frame image sent by the sending section 502, by reference to the commodity images in the PLU file F1, the object recognition section 504 recognizes a commodity serving as a specific object by reading characteristics of the received frame images (A702).

After the commodity is recognized, the commodity registration section 505 determines whether or not a commodity list is received in addition to the frame image and the shopping basket ID (A703). If no commodity list is received (A703: No), the commodity registration section 505 reads the sales registration information of the recognized commodity from the PLU file F1, generates a commodity list in which the read sales registration information is recorded, and stores the generated commodity list in the storage medium 213 of the shopping basket 153 (A704). Next, the settlement section 506 determines whether or not to settle the commodities in the shopping basket 153, that is, whether or not the commodity settlement button 153c is pressed down to initiate a commodity settlement request from the shopping basket 153. If there is no commodity settlement request initiated from the shopping basket 153 (A705: No), the flow returns to Act A701 so that the receiving section 503 can receive a frame image.

On the other hand, if there is a commodity settlement request initiated from the shopping basket 153 (A705: Yes), the settlement section 506 settles the commodities the sales information of which is recorded in the commodity list received by the receiving section 503 when the commodity settlement button 153c is pressed down.

Moreover, in the case where a commodity list is received in addition to the frame image and the shopping basket ID (A703: Yes), the commodity registration section 505 compares the commodities the sales registration information of which is recorded in the commodity list received by the receiving section 503 with the recognized commodities to determine whether or not commodities are added to the shopping basket 153 (A707). Moreover, if it is determined that commodities are added to the shopping basket 153 (A707: Yes), the commodity registration section 505 reads, from the PLU file F1, the sales registration information of the ones of the recognized commodities the sales registration information of which is not recorded in the received commodity list (namely, the commodities added to the shopping basket 153), and records the information of the commodities added to the shopping basket 153 in the received commodity list (A708). Then, the commodity registration section 505 stores the commodity list containing the sales registration information of the commodities added to the shopping basket 153 in the storage medium 213 of the shopping basket 153 specified by the received shopping basket ID.

For instance, as shown in FIG. 8, the shot image acquisition section 501 acquires a frame image 800 of the commodities in the shopping basket 153 that is shot by the shooting unit 153b and contains commodity images 801-803 of the commodities A-C accommodated in the shopping basket 153. The sending section 501 sends the frame image 800 acquired by the shot image acquisition section 501, the shopping basket ID of the shopping basket 153 and a commodity list to the POS terminal 11. Then, after the receiving section 503 receives the frame image 800, the shopping basket ID and the commodity list, the object recognition section 504 recognizes commodities A-C serving as specific objects by reading characteristics of the received frame image 800. Next, the commodity registration section 505 compares the commodities A and B the sales registration information of which is recorded in the received commodity list with the recognized commodities A-C to find the addition of the commodity C to the shopping basket 153. Then, the commodity registration section 505 records the sales registration information of the commodity C in the received commodity list. Sequentially, the commodity registration section 505 stores the commodity list containing the sales registration information of the commodity C in the storage medium 213 of the shopping basket 153 specified by the received shopping basket ID.

Return to FIG. 7, on the other hand, if it is determined that no commodity is added to the shopping basket 153 (A707: No), the commodity registration section 505 compares the commodities the sales registration information of which is recorded in the commodity list received by the receiving section 503 with the recognized commodities to determine whether or not commodities are taken out of the shopping basket 153 (A709). If it is determined that commodities are taken out of the shopping basket 153 (A709: Yes), the commodity registration section 505 deletes the sales registration information of the commodities which are not recognized by the object recognition section 504 and the sales registration information of which is recorded in the received commodity list (namely, the commodities taken out of the shopping basket 153) (A710). Then, the commodity registration section 505 stores the commodity list containing no sales registration information of the commodities taken out of the shopping basket 153 in the storage medium 213 of the shopping basket 153 specified by the received shopping basket ID.

For instance, as shown in FIG. 9, the shot image acquisition section 501 acquires a frame image 900 of the commodities in the shopping basket 153 that is shot by the shooting unit 153b and contains commodity images 901 and 902 of the commodities A and B accommodated in the shopping basket 153. The sending section 502 sends the frame image 900 acquired by the shot image acquisition section 501, the shopping basket ID of the shopping basket 153 and a commodity list to the POS terminal 11. Then, after the receiving section 503 receives the frame image 900, the shopping basket ID and the commodity list, the object recognition section 504 recognizes the commodities A and B serving as specific objects by reading characteristics of the received frame image 900. Next, the commodity registration section 505 compares the commodities A-C the sales registration information of which is recorded in the received commodity list with the recognized commodities A and B to find that the commodity C is taken out of the shopping basket 153. Then, the commodity registration section 505 deletes the sales registration information of the commodity C from the received commodity list. Next, the commodity registration section 505 stores the commodity list from which the sales registration information of the commodity C is deleted in the storage medium 213 of the shopping basket 153 specified by the received shopping basket ID.

An example of the recognition on the commodities in the shopping basket 153 based on a received frame image and the generation of a commodity list in which the sales registration information of the recognized commodities is recorded is described here with reference to FIG. 10. For instance, in the case where commodities A and B are accommodated in the shopping basket 153 and a frame image 1000 containing commodity images 1001 and 1002 of the commodities A and B is received, the object recognition section 504 compares the commodity images 1001 and 1002 contained in the frame image 1000 with commodity images (reference images) 1004 and 1005 in the PLU file F1, and then recognizes the commodities A and B the commodity images 1001 and 1002 of which are contained in the frame image 1000 as the commodities accommodated in the shopping basket 153 on condition that the surface states read from the commodity images 1001 and 1002 as characteristics are identical to those of the commodity images 1004 and 1005. Sequentially, the commodity registration section 505 reads the sales registration information of the recognized commodities A and B from the PLU file F1, generates a commodity list 1006 in which the read sales registration information (e.g. commodity name) is recorded, and stores the generated commodity list 1006 in the storage medium 213.

Return to FIG. 7, if it is determined that no commodities are taken out of the shopping basket 153 (A709: No), the settlement section 506 determines whether or not a commodity settlement request is initiated by the shopping basket 153, that is, whether or not the commodity settlement button 153c is pressed down to initiate a commodity settlement from the shopping basket 153 (A705).

If there is no request for the settlement of the commodities in the shopping basket 153 (A705: No), the flow returns to Act A701 so that the receiving section 503 can receive a frame image.

On the other hand, if there is a request for the settlement of the commodities in the shopping basket 153 (A705: Yes), the settlement section 506 settles the commodities the sales information of which is recorded in the commodity list received by the receiving section 503 (A706).

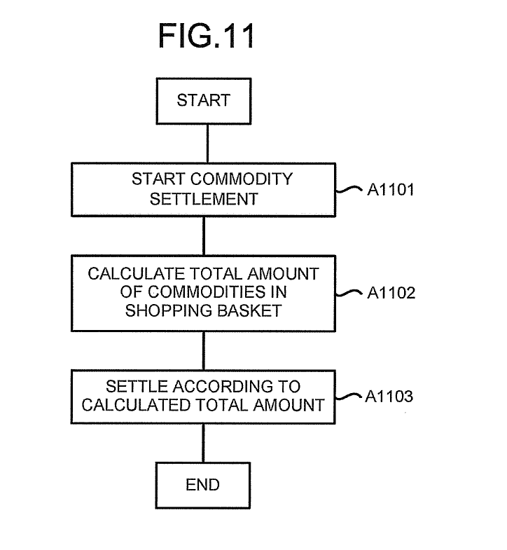

The settlement actions of the POS terminal 11 are described in detail below. FIG. 11 is a flow chart showing an example of the settlement actions carried out by the POS terminal in this embodiment.

The settlement section 506 settles the commodities the sales registration information of which is recorded in the commodity list received by the receiving section 503 (A1101) after the commodity settlement button 153c of the shopping basket 153 is pressed down.

The settlement section 506 calculates the total amount of the commodities accommodated in the shopping basket 153 (A1102) with reference to the unit prices that are recorded in the received commodity list as sales registration information, and then settles for the commodities accommodated in the shopping basket 153 (A1103) with reference to the calculated total amount.

Thus, in accordance with the checkout lane system 1 described in this embodiment, the shopping basket 153 comprises: a shooting unit 153b arranged to shoot a frame image of the commodities accommodated in the shopping basket 153; a shot image acquisition section 501 arranged to acquire the shot frame image; and a sending section 502 arranged to send a shopping basket ID specifying the shopping basket 153 and the acquired frame image to the POS terminal 11. The POS terminal 11 comprises: a receiving section 503 arranged to receive the sent frame image and shopping basket ID; an object recognition section 504 arranged to recognize commodities according to the received frame image; and a commodity registration section 505 arranged to register the sales of the recognized commodities for each shopping basket 153 specified by the received shopping basket ID. Thus, a shop assistant can carry out a commodity sales registration without recognizing the commodities in the shopping basket 153 and is therefore relieved in workload.

Further, the programs executed by the POS terminal 11 and the shopping cart 200 in this embodiment are compiled in an ROM in advance, or may be stored in a computer-readable memory medium such as CD-ROM, floppy drive (FD), CD-R, digital versatile disk (DVD) as an installable or executable file, or stored in a computer connected with a network such as the Internet to be provided through a network download, or provided or published by a network such as the Internet.

The programs executed by the POS terminal 11 in this embodiment consist of modules including each of the foregoing units (the receiving section 503, the object recognition section 504, the commodity registration section 505 and the settlement section 506), however, as an actual piece of hardware, a CPU reads the programs from the ROM and then executes the programs to load each of the foregoing units to a main memory device to generate the receiving section 503, the object recognition section 504, the commodity registration section 505 and the settlement section 506 on the main memory device.

The programs executed by the shopping cart 200 consist of modules including each of the foregoing units (the shot image acquisition section 501 and the sending section 502), however, as an actual piece of hardware, a CPU reads the programs from the ROM and then executes the programs to load each of the foregoing units to a main memory device to generate the shot image acquisition section 501 and the sending section 502 on the main memory device.

Moreover, in this embodiment, the CPU 61 of the POS terminal 11 can function as the object recognition section 504, however, the present invention is not limited to this, the CPU 211 at the side of the shopping cart 200 may also function as the object recognition section 504. In the case where the CPU 211 at the side of the shopping cart 200 functions as the object recognition section 504, the sending section 502 sends commodity information such as a commodity ID for specifying a recognized commodity, instead of a frame image (a shot image), and a shopping basket ID to the POS terminal 11. Then, the commodity registration section 505 of the POS terminal registers the sales of the commodities specified by the received commodity information for each shopping basket 153 specified by the received shopping basket ID.

Moreover, in this embodiment, the CPU 61 of the POS terminal 11 can function as the receiving section 503, the object recognition section 504 and the commodity registration section 505, however, the present invention is not limited to this, the CPU of the store computer SC (server) may also function as the receiving section 503, the object recognition section 504 and the commodity registration section 505.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity accommodation apparatus, comprising:
an accommodation unit configured to accommodate commodities;
a shooting unit configured to shoot an image of the interior of the accommodation unit; and
a sending section configured to send an identification information for specifying one's own identity and the shot image to a commodity registration apparatus.

2. The commodity accommodation apparatus according to claim 1, further comprising:
a recognition section configured to recognize commodities according to the shot image, wherein
the sending section sends the commodity information of the recognized commodities, instead of the shot image, together with the identification information to the commodity registration apparatus.

3. A commodity registration apparatus, comprising:
a receiving section configured to receive an image of the interior of a commodity accommodation unit and an identification information for specifying a commodity accommodation apparatus which includes the commodity accommodation unit;
a recognition section configured to recognize commodities according to the received shot image; and
a registration unit configured to register the sales of the recognized commodities for each commodity accommodation apparatus specified by the received identification information.

4. The commodity registration apparatus according to claim 3, wherein
the receiving section receives the shot image and the identification information at given intervals; and
the registration unit registers the sales of the ones of the recognized commodities that the sales is not registered with respect to the commodity accommodation apparatus specified by the received identification information, and removes the sales of the commodity that is registered with respect to the commodity accommodation apparatus specified by the received identification information and is not included in the recognized commodities.

5. The commodity registration apparatus according to claim 4, wherein
the registration unit registers the sales of the recognized commodities for each commodity accommodation apparatus by storing the recognized commodities in a storage unit that is included in the commodity accommodation apparatus specified by the received identification information.

6. A commodity registration method carried out in a shop system which includes a commodity accommodation apparatus includes an accommodation unit accommodates commodities and a shooting unit shoots an image of the interior of the accommodation unit, and a commodity registration apparatus registers the sales of the commodities, comprising:
sending an identification information for specifying the commodity accommodation apparatus and the shot image to a commodity registration apparatus;
receiving the sent image and the identification information;
recognizing commodities according to the received image; and
registering the sales of the recognized commodities for each commodity accommodation apparatus specified by the received identification information.
